(19) United States
(12) Patent Application Publication
(10) Pub. No.: US 2012/0056793 A1
(43) Pub. Date: Mar. 8, 2012

(54) REFLECTOR AND PARABOLIC ANTENNA USING THE SAME

(76) Inventor: Taiki Sato, Tokyo (JP)

(21) Appl. No.: 13/319,639

(22) PCT Filed: May 21, 2010
(86) PCT No.: PCT/JP2010/059051

§ 371 Date: Nov. 9, 2011

(30) Foreign Application Priority Data
May 22, 2009 (JP) 2009-123693

(51) Int. Cl. H01Q 15/14; H01Q 13/00

(52) U.S. Cl. 343/781 CA; 343/912

(57) ABSTRACT

A reflector includes a reflective body 3 which reflects a radio wave, an engaging part 3a which is formed in the reflective body 3, a supporting body 4 which supports the reflective body 3, an engaged part 4a which is formed in the supporting body 4 and receives the engaging part 3a, and an insertion amount regulation part which regulates an insertion amount when the engaging part 3a is inserted into the engaged part 4a.

### TECHNICAL FIELD

The present invention relates to a reflector and a parabolic antenna using the reflector.

### BACKGROUND ART

A parabolic antenna including a main-reflector, a sub-reflector and a waveguide is known. The sub-reflector is constructed so that an electric wave reflected by the main-reflector may be incident into a circular waveguide feeder. In such parabolic antenna, in order to prevent degradation or the like of reflection characteristics, it is preferred that the main-reflector, the waveguide and the sub-reflector are fixed in the state that the respective axis lines of them are aligned.

For example, in Japanese Patent Application Laid-Open No. 1997-199937, a parabolic antenna apparatus is disclosed. This parabolic antenna apparatus includes a main-reflector, a circular waveguide feeder which is attached in the main-reflector, a feedome of a hollow body which is provided in a head of the circular waveguide feeder, and a sub-reflector which is inserted in and fixed to the feedome.

The main-reflector, the circular waveguide feeder, the feedome and the sub-reflector are rotational symmetric bodies having respective axis lines. The circular waveguide feeder is installed so that it is aligned with the axis line of the main-reflector, and the feedome is inserted in and fixed to its end part in the opposite side of the main-reflector. Accordingly, the axis line of the feedome is aligned with the axis line of the main-reflector. Further, the sub-reflector is inserted in and fixed to the feedome. As a result, because the axis line of the sub-reflector is aligned with the axis line of the feedome, the axis line of the sub-reflector is aligned with the axis line of the main-reflector.

### DISCLOSURE OF THE INVENTION

However, in the parabolic antenna apparatus according to Japanese Patent Application Laid-Open No. 1997-199937, because a means to regulate an insertion amount of the sub-reflector when inserting and fixing the sub-reflector to the feedome is not provided, a variation of a position in the axis line direction of the sub-reflector is caused. By this variation, there is a problem that reflection characteristics of a radio wave degrade. Accordingly, it is desired that the axis lines of the main-reflector, the waveguide and the sub-reflector are aligned and, at the same time, a position of the sub-reflector at least relative to the main-reflector can be regulated correctly.

Accordingly, a main object of the present invention is to provide a reflector in which a position of the reflective body (sub-reflector) in a direction of an axis line and in a direction vertical to the axis line can be regulated easily, and a parabolic antenna using this reflector.

### Means for Solving the Problem

In order to settle the above-mentioned problem, a reflector according to the present invention includes a reflective body which reflects a radio wave, an engaging part which is formed in the reflective body, a supporting body which supports the reflective body, an engaged part which is formed in the supporting body and is engaged with the engaging part, and an insertion amount regulation part which regulates an insertion amount when the engaging part engages into the engaged part.

Also, a parabolic antenna includes a main-reflector for reflecting a radio wave, a reflector according to any one of claims 1-16, and a waveguide, wherein a radio wave reflected from the main-reflector is further reflected by the reflector, and is introduced inside the waveguide.

### Advantage of the Invention

According to the present invention, a position in the direction of the axis line of the reflective body and in the direction vertical to this axis line can be regulated easily.

### BRIEF DESCRIPTION OF THE DRAWINGS

FIG. 1A is a sectional view of a reflective body in a reflector of a first exemplary embodiment according to the present invention.

FIG. 1B is a sectional view of a supporting body in a reflector of the first exemplary embodiment.

FIG. 1C is a sectional view of a reflector of the first exemplary embodiment.

FIG. 2 is a fragmentary sectional view of a parabolic antenna of a second exemplary embodiment according to the present invention.

FIG. 3A is a sectional view of a sub-reflector in a parabolic antenna according to the second exemplary embodiment.

FIG. 3B is a sectional view of a supporting body in a parabolic antenna according to the second exemplary embodiment.

FIG. 3C is a sectional view of a waveguide in a parabolic antenna according to the second exemplary embodiment.

FIG. 3D is a fragmentary sectional view of a main-reflector in a parabolic antenna according to the second exemplary embodiment.

FIG. 4A is a sectional view of a sub-reflector and a supporting body when the sub-reflector and the supporting body are facing each other according to the second exemplary embodiment.

FIG. 4B is a sectional view of a sub-reflector and a supporting body at the time when an engaging part according to the second exemplary embodiment hits a supporting face.

FIG. 4C is a sectional view of a sub-reflector and a supporting body when an engaging part according to the second exemplary embodiment has been inserted in an engaged part.

FIG. 5A is a sectional view of a sub-reflector and a supporting body of the second exemplary embodiment when the sub-reflector and the supporting body are facing each other in the state that the axis lines of them are not aligned.

FIG. 5B is a sectional view of a sub-reflector and a supporting body of the second exemplary embodiment when a sub-reflecting face hits a supporting face.

FIG. 5C is a sectional view of a sub-reflector and a supporting body of the second exemplary embodiment when the sub-reflector is fixed to the supporting body.

FIG. 6 is a sectional view of a parabolic antenna of the third exemplary embodiment of the present invention having a reflector including an engagement cylinder in a periphery part of a sub-reflector.

FIG. 7 is a sectional view of a parabolic antenna of the third exemplary embodiment of the present invention having a reflector including an engagement cylinder in a periphery part of a supporting body.

FIG. 8 is a sectional view of a parabolic antenna having a reflector according to a fourth exemplary embodiment of the present invention.

FIG. 9 is a partial grossly enlarged sectional view of a supporting body of the fourth exemplary embodiment.

FIG. 10A is a sectional view of a sub-reflector and a supporting body according to the fourth exemplary embodiment when the sub-reflector and the supporting body are facing each other.

FIG. 10B is a sectional view of a sub-reflector and a supporting body according to the fourth exemplary embodiment at the time when a sub-reflecting face touches an adhesion material.

FIG. 10C is a sectional view of a sub-reflector and a supporting body according to the fourth exemplary embodiment when a sub-reflecting face touches a supporting face.

FIG. 11A is a sectional view of a sub-reflector of a fifth exemplary embodiment of the present invention having an engaging part.

FIG. 11B is a sectional view when bonding a sub-reflector of the fifth exemplary embodiment to a supporting body.

FIG. 11C is a partial grossly enlarged sectional view of area A in FIG. 11B.

FIG. 12A is a sectional view of a sub-reflector and a supporting body of a sixth exemplary embodiment of the present invention in which a tapered portion is provided in a periphery part of the sub-reflector and the supporting body.

FIG. 12B is a sectional view when bonding a sub-reflector of the sixth exemplary embodiment to a supporting body.

FIG. 13A is a sectional view of a sub-reflector and a supporting body of the seventh exemplary embodiment of the present invention in which a tapered portion is provided in a periphery part of the supporting body.

FIG. 13B is a sectional view when bonding a sub-reflector of a seventh exemplary embodiment to a supporting body.

FIG. 14A is a partial top view of a supporting body according to an eighth exemplary embodiment of the present invention.

FIG. 14B is an arrowed cross-sectional view taken along line A-A of FIG. 14A.

FIG. 15 is a sectional view of a reflector of the eighth exemplary embodiment which does not have an engaging part and an engaued part.

FIG. 16 is a sectional view of a reflector which does not have an adhesion material dropping slot part according to the eighth exemplary embodiment.

FIG. 17 is a sectional view of a reflector having an adhesion material dropping slot part according to the eighth exemplary embodiment.

### BEST MODE FOR CARRYING OUT THE INVENTION

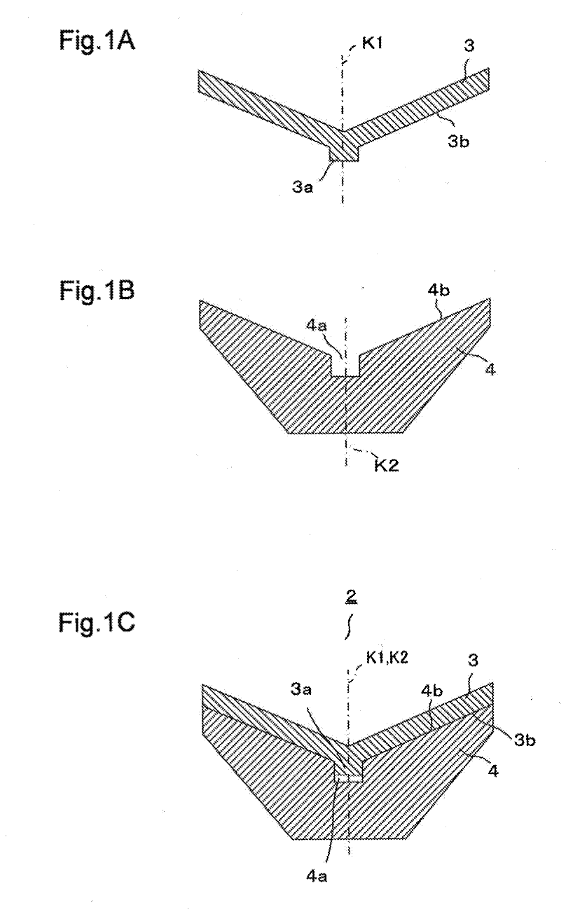

A first exemplary embodiment of the present invention will be described with reference to a drawing. FIG. 1A is a sectional view of a reflective body in a reflector of the first exemplary embodiment according to the present invention. FIG. 1B is a sectional view of a supporting body in a reflector of the first exemplary embodiment. FIG. 1C is a sectional view of a reflector of the first exemplary embodiment. As shown in FIG. 1C, a reflector 2 includes an engaging part 3a and an engaged part 4a formed in a reflective body 3 and a supporting body 4, respectively, and insertion amount regulation parts 3b and 4b.

The reflective body 3 is a rotational symmetric body of a dish shape which takes an axis line K1 as a rotational symmetric axis, and the supporting body 4 is a rotational symmetric body which takes an axis line K2 as a rotational symmetric axis. Meanwhile, when the term “sectional view” is described in the following description, unless otherwise noted, it means a sectional view along the axis line of each member. For example, the reflective body 3 in FIG. 1A is a sectional view along the axis line K1.

The face of the reflective body 3 in the supporting body 4 side forms a reflecting face (the insertion amount regulation part) 3b, and the face of the supporting body 4 in the reflective body 3 side forms a supporting face (the insertion amount regulation part) 4b.

The engaging part 3a is a cylindrical body formed convexly from the reflecting face 3b, and the engaged part 4a is a cylindrical hole formed concavely from the supporting face 4b. By inserting the engaging part 3a into the engaged part 4a, the axis line K1 of the reflective body 3 is aligned with the axis line K2 of the supporting body 4. When the engaging part 3a is inserted in the engaged part 4a, an insertion amount of the engaging part 3a to the engaged part 4a is regulated by contacting the reflecting face 3b and the supporting face 4b.

Accordingly, by fitting of the engaged part 4a and the engaging part 3a, the axis line K1 of the reflective body 3 and the axis line K2 of the supportine body 4 are aligned. Also, a position of the reflective body 3 in a direction along the axis line K1 (or the axis line K2) to the supporting body 4 is regulated by the reflecting face 3b hitting the supporting face 4b. Therefore, it becomes possible to set a position of the reflective body 3 relative to the supporting body 4 to a predetermined position easily.

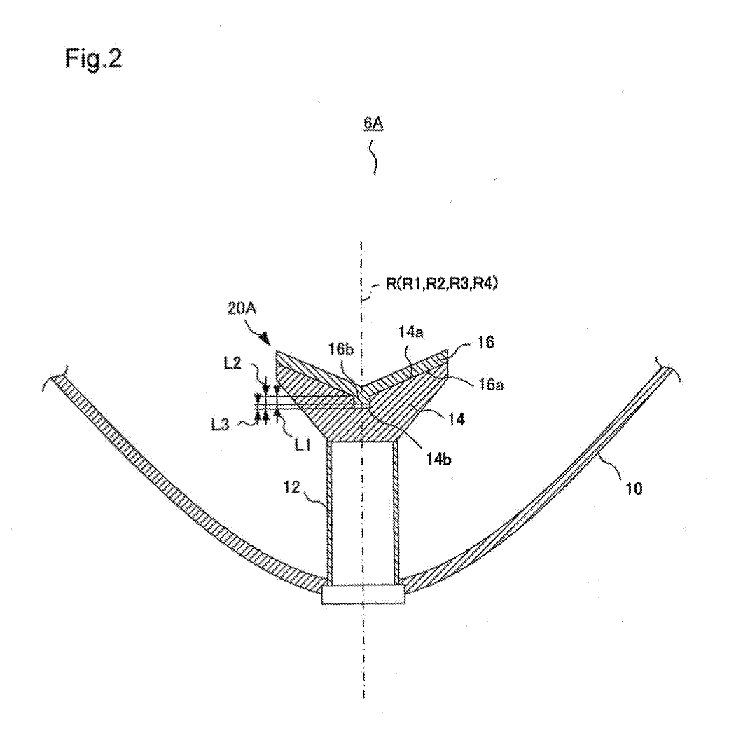

Next, a second exemplary embodiment of the present invention will be described. FIG. 2 is a fragmentary sectional view of a parabolic antenna GA of the second exemplary embodiment according to the present invention. The parabolic antenna 6A includes a main-reflector 10, a waveguide 12, a supporting body 14 and a sub-reflector (reflective body) 16. Here, the supporting body 14 and the sub-reflector 16 that is a reflective body form a reflector 20A. The main-reflector 10, the waveguide 12, the supporting body 14 and the sub-reflector 16 are rotational symmetric bodies of a dish shape which take an axis line R as a rotating shaft.

In the meantime, as will be mentioned later, a sub-reflecting face 16a and an engaging part 16b are included in the sub-reflector 16 and a supporting face 14a and an engaged part 14b are included in the supporting body 14. The sub-reflecting face 16a and the supporting face 14a also function as an insertion amount regulation part. Description of the function of this insertion amount regulation part will be made later. The reflector 20A includes the engaging part 16b, the engaged part 14b, the sub-reflecting face (insertion amount regulation part) 16a and the supporting face (insertion amount regulation part) 14a.

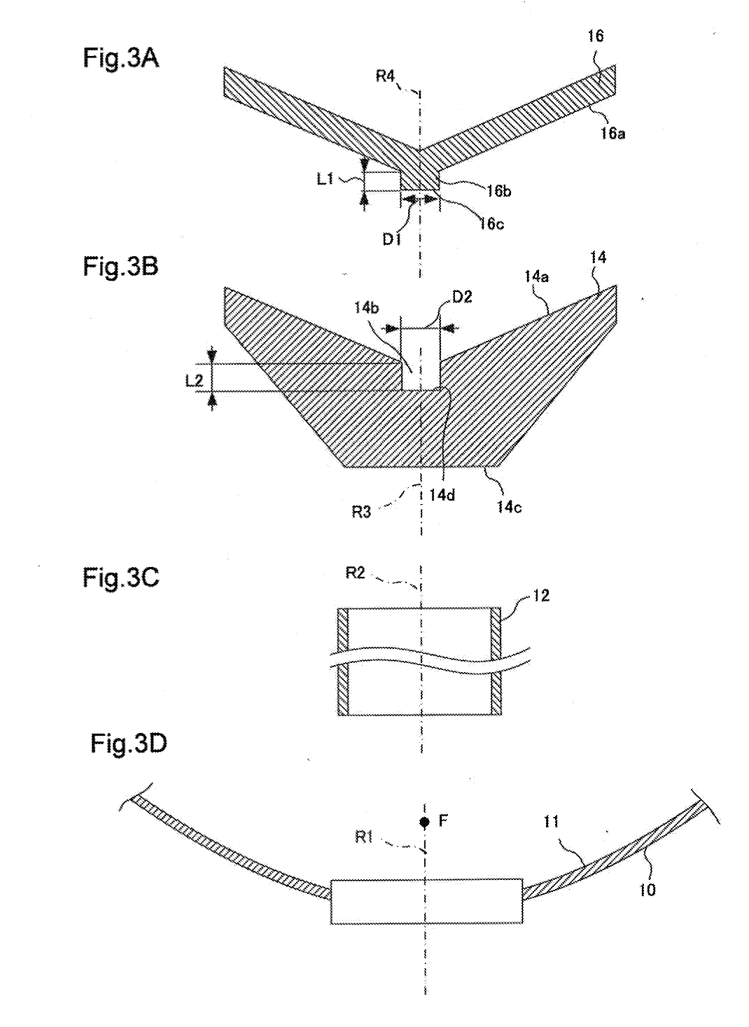

FIG. 3A is a sectional view of the sub-reflector 16, FIG. 3B is a sectional view of the supporting body 14, FIG. 3C is a sectional view of the waveguide 12, and FIG. 3D is a fragmentary sectional view of the main-reflector 10. As shown in FIGS. 3A-FIG. 3D, the axis line of the main-reflector 10 is described as R1, the axis line of the waveguide 12 as R2, the axis line of the supporting body 14 as R3 and the axis line of the sub-reflector 16 as R4, and these are collectively described as an axis line R. Accordingly, in the parabolic antenna 6A shown in FIG. 2, a state that the axis lines R1-R4 are overlapped is indicated as the axis line R.

As shown in FIG. 3D, the main-reflector 10 includes a main-reflecting face 11 such as a paraboloid and reflects a radio wave. The main-reflecting face 11 acts so that a radio wave may be reflected to the sub-reflecting face 16a of the sub-reflector 16. A radio wave reflected by the sub-reflecting face 16a is introduced into the inside of the waveguide 12.

As shown in FIG. 2 and FIG. 3C, the waveguide 12 leads a microwave or the like by a hollow metal pipe installed on the main-reflecting face 11 in a standing manner. The supporting body 14 is fixed to the end part of the waveguide 12 in the opposite side of the main-reflecting face 11.

The sub-reflector 16 is formed out of a metal material such as aluminum using a processing method such as cutting and stamp forging. The face of the sub-reflector 16 in the supporting body 14 side performs as a sub-reflecting face (insertion amount regulation part) 16a. As shown in FIG. 3A, the engaging part 16b which forms a convex cylindrical body is provided coaxially with the axis line R4.

Hereinafter, it will be explained that like a side face of a circular truncated cone, the face of the sub-reflecting face 16a has a curvature in circumferential direction (a direction around the axis line R4), but does not have a curvature in a radial direction (a direction vertical to the axis line R4). However, the sub-reflecting face 16a may be of a face with a curvature in a radial direction like a hyperboloid or the like.

As shown in FIG. 3B, the supporting body 14 includes the supporting face (insertion amount regulation part) 14a, the engaged part 14b and a fixing part 14c. The supporting face 14a is a face to which the sub-reflector 16 is glued by an adhesion material, and it is formed having a similar figure to the sub-reflecting face 16a. The engaged part 14b is formed into the supporting face 14a coaxially with the axis line R3, and is a cylindrical hole (receiving hole) which the engaging part 16b of the sub-reflector 16 fits. The fixing part 14c is a face in the opposite side of the supporting face 14a, and forms a joint part between the supporting body 14 and the waveguide 12.

This supporting body 14 is formed out of a resin material such as a polycarbonate of a low dielectric constant using a method such as cutting and injection molding. The reason to form the supporting body 14 using a material of a low dielectric constant is in order to make the reflection loss small. In this meaning, it is desirable to form the supporting body 14 out of a material by which a reflection loss becomes small, and thus it is not necessary to he limited to polycarbonate.

As shown in FIG. 2, FIG. 3A and FIG. 3B, a height L1 of the engaging part 16b of the sub-reflector 16 is smaller than a depth L2 of the engaged part 14c of the supporting body 14 by a predetermined amount L3 (L2−L1+L3). The size L3 is an escape size to prevent an end face 16c of the engaging part 16b from hitting a bottom face 14d of the engaged part 14b before the sub-reflecting face 16a touches the supporting face 14a when the engaging part 16b is inserted in the engaged part 14b.

As shown in FIG. 3A and FIG. 3B, when it is assumed that the inside diameter of the engaged part 14b is D2, a diameter D1 of the engaging part 16b is D2=D1+D3. Here, the size D3 is a fabrication tolerance. Accordingly, the diameter D1 of the engaging part 16b is equal to the inside diameter D2 of the engaged part 14b within the range of a fabrication error. Therefore, when the engaging part 16b is inserted in the engaged part 14b, the axis line R4 of the sub-reflector 16 is aligned with the axis line R3 of the supporting body 14 within the range of a fabrication error.

When it is supposed that the wavelength of a reflected radio wave is λ, in order to suppress a degradation of the return-loss characteristics of the radio wave which passes the supporting body 14, it is desirable to set the height L1 of the engaging part 16b and the inside diameter D2 of the engaged part 14b such that L1<λ/4 and D2<λ/4. For example, assuming that a 2-foot antenna which reflects a radio wave of a frequency of 23 GHz and that the height L1 of the engaging part 16b is set 1 mm. Because λ/4 is about 3.0 mm, D2 is set such that D2<3.0 mm.

Such the engaging part 16b, the engaged part 14b, the sub-reflecting face (insertion amount regulation part) 16a and the supporting face 14a form the reflector 20A, and a position of the sub-reflector 16 relative to the supporting body 14 is regulated by this reflector 20A. Meanwhile, when the sub-reflector 16 is fixed to the supporting body 14, an adhesive material is used.

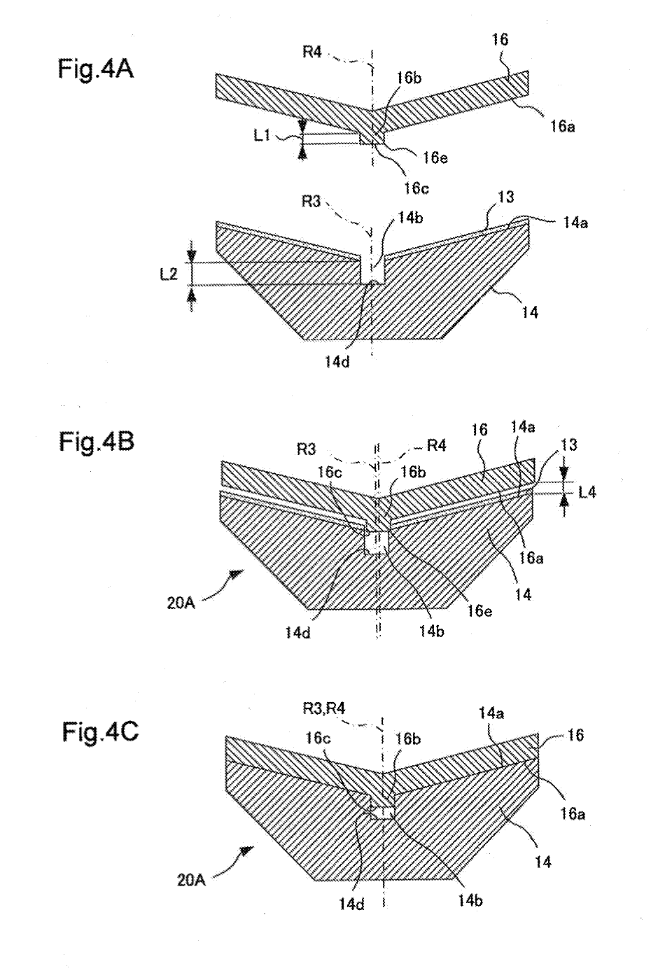

FIGS. 4A-4C are sectional views of the sub-reflector 16 and the supporting body 14 which indicate a procedure to bond the above-mentioned sub-reflector 16 and supporting body 14 together. FIG. 4A is a sectional view when the sub-reflector 16 and the supporting body 14 are facing each other. FIG. 4B is a sectional view when the engaging part 16b hits the supporting face 14a. FIG. 4C is a sectional view when the engaging part 16b is inserted in the engaged part 14b.

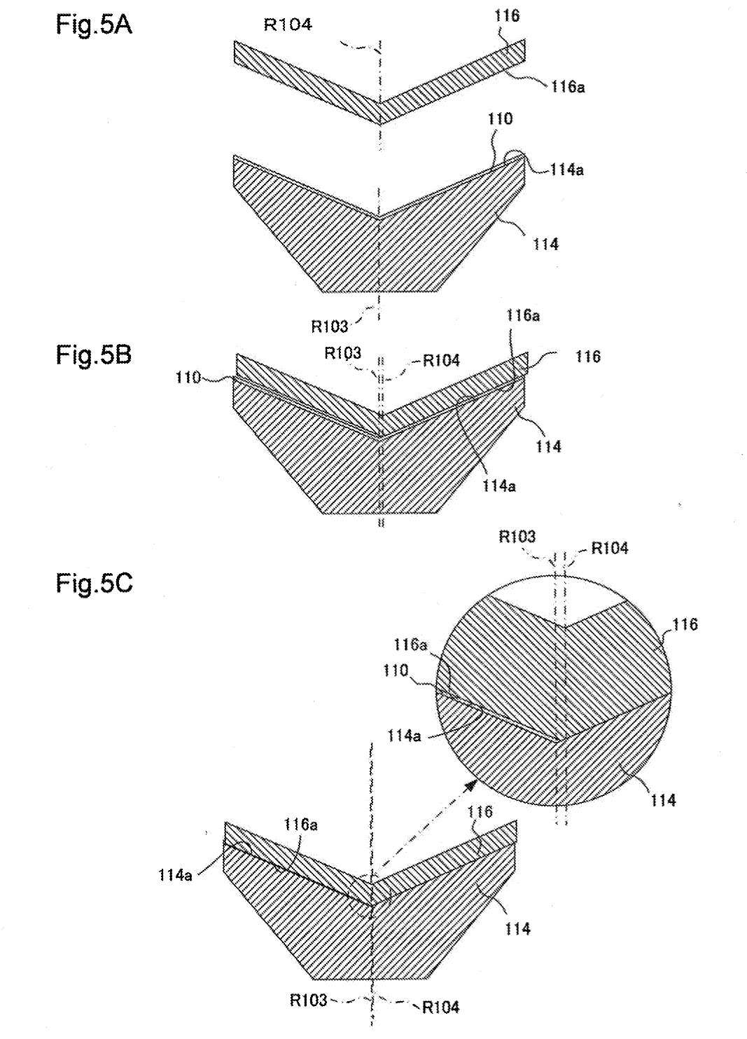

On the other hand, FIGS. 5A-5C are sectional views of a sub-reflector 116 and a supporting body 114, which do not have the reflector 20A mentioned above, indicating a procedure for bonding the sub-reflector 116 and the supporting body 114 together. FIG. 5A is a sectional view when the sub-reflector 116 and a supporting body 114 are facing each other, and FIG. 5B is a sectional view when a sub-reflecting face 116a hits a supporting face 114a, and FIG. 5C is a sectional view when the sub-reflector 116 is fixed to the supporting body 114.

First, a bonding procedure of the sub-reflector 116 and the supporting body 114 which do not have the reflector 20A shown in Figs. 5A-5C will be described. An adhesive material 110 is applied to a supporting face 114a of the supporting body 114. Then, as shown in FIG. 5A, the sub-reflector 116 and the supporting body 114 are made face each other in the state that an axis line R104 of the sub-reflector 116 is aligned with an axis line R103 of the supporting body 114.

Next, while keeping the state that the axis line R104 and the axis line R103 are aligned, the sub-reflector 116 is moved toward the supporting body 114 side, 1. By an error of a robot's grasping accuracy or an position accuracy after movement and an error of an installed position of supporting body 114, the axis line 8104 of the sub-reflector 116 and the axis line R103 of the supporting body 14 may cause a positional displacement as shown in FIG. 5B. Of course, when the sub-reflector 116 is held and moved by handwork, a positional displacement of the axis line R104 and the axis line R103 may become larger.

When a positional displacement between the axis line R104 and the axis line R103 is large, it is possible to detect this positional displacement by a position sensor or by a visual check or the like to adjust their positions. However, in a case of a small positional displacement amount, because it cannot be detected easily, position adjustment of the sub-reflector 116 becomes difficult. For this reason, as shown in FIG. 5C, there occurs a case where the sub-reflector 116 is bonded to the supporting body 114 in the state that the positions of the axis line R104 and the axis line R103 are misaligned.

Bonding the sub-reflector 116 to the supporting body 114 in the state that the axis line R104 and the axis line R103 have a positional displacement means that, relative to the supporting body 114, the position of the sub-reflector 116 is shifted in a radial direction and also shifted in a direction of the axis line R104 (R103). As a result, even if the axis lines of the waveguide 12, the main-reflector 10 and the supporting body 114 are aligned, the reflection characteristics of a radio wave reflected by the sub-reflector 116 will be asymmetry.

In contrast, as shown in FIGS. 4A-4C, the reflector 20A equipped with the engaging part 16b and the engaged part 14b and the like according to the second exemplary embodiment can suppress such positional displacement of the sub-reflector 16 relative to the supporting body 14.

In FIG. 4A, it is supposed that the axis line R4 of the sub-reflector 16 and the axis line R3 of the supporting body 14 are facing each other having a positional displacement as shown in FIG. 5B. When, from such state, the sub-reflector 16 is moved toward the side of the supporting body 14 to which an adhesive material 13 has been applied, an edge 16e of the engaging part 16b hits the supporting face 14a as shown in FIG. 4B.

The height L1 (refer to FIG. 4A) of the engaging part 16b is of the order of millimeters. Accordingly, when the edge 16e of the engaging part 16b hits the supporting face 14a, an opening with a size of the order of millimeters (this size is described by L4) is formed between the sub-reflecting face 16a and the supporting face 14a (refer to FIG. 4B). If it is such a large size, even by an inexpensive sensor, it can be detected easily and certainly, and it can also be checked with eyes. Accordingly, it becomes possible to perform position adjustment in which a position of the sub-reflector 16 is shifted in a radial direction based on this detection result.

By adjusting a position of the sub-reflector 16 in a radial direction, the engaging part 16b fits the engaged part 14b. In other words, position adjustment of the sub-reflector 16 is made in a radial direction so that the engaging part 16b may fit the engaged part 14b. When the sub-reflector 16 is moved further toward the supporting body 14 side in the state that the engaging part 16b is fitted into the engaged part 14b, the sub-reflecting face 16a hits the supporting face 14a.

Accordingly, a position of the sub-reflector 16 in a radial direction is regulated by the engaging part 16b fitting the engaged part 14b, and a position of the sub-reflector 16 in a direction of the axis line R3 (R4) is also regulated by the sub-reflecting face 16a hitting the supporting face 14a. Therefore, as shown in FIG. 4C, the sub-reflector 16 can be bonded to the supporting body 14 at a predetermined position.

Further, as stated above, when the end face 16c of the engaging part 16b hits the bottom face 14d of the engaged part 14b, there occurs a case where the sub-reflecting face 16a does not come to touch the supporting face 14a. Therefore, it is arranged such that, by making the depth L2 (refer to FIG. 4A) of the engaged part 14b deeper than the height L1 of the engaging part 16b by the size L3, the end face 16c of the engaging part 16b and the bottom face 14d of the engaged part 14b do not touch each other. As a result, because the supporting face 14a touches the sub-reflecting face 16a certainly, a positional displacement of a position in a direction of the axis line of the sub-reflector 16 can be prevented.

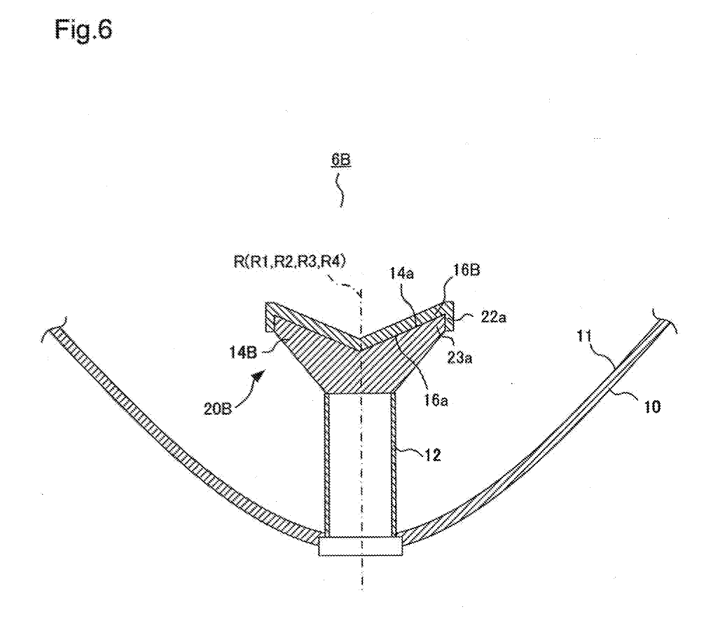

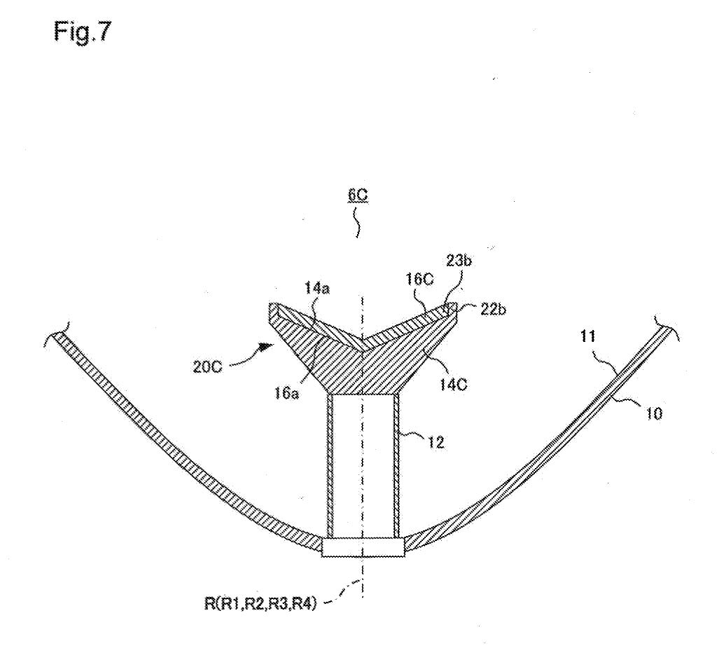

Next, a third exemplary embodiment of the present invention will be described. Meanwhile, description will be omitted appropriately about a structure identical with a structure of the second exemplary embodiment by using an identical symbol. According to the second exemplary embodiment, in order to make the axis line of a sub-reflector aligned with the axis line of a supporting body, an engaging part of a cylindrical body is provided in the sub-reflector, and an engaged part of a cylindrical hole is provided in the supporting body. However, the present invention is not limited to such structure, and it may be a reflector 20B and 20C including engagement cylinders (engaging parts) 22a and 22b, and engaged parts 23a and 23b as shown in FIG. 6 and FIG. 7, for example.

FIG. 6 is a sectional view of a parabolic antenna 6B having the reflector 20B in which the engagement cylinder 22a is provided in a periphery part of a sub-reflector 16B. Because the sub-reflector 16B is of a dish shape, the engagement cylinder 22a provided in the side face of its periphery has a cylinder-like shape. The periphery part of a supporting body 14B functions as an engaged part 23a, and the sub-reflecting face 16a of the sub-reflector 16B and the supporting face 14a of the supporting body 14B function as an insertion amount regulation part.

When the sub-reflector 16B is bonded to the supporting body 14B, by fitting the engagement cylinder 22a into the engaged part 23a, the axis line R4 of the sub-reflector 16B and the axis line R3 of the supporting body 14B can be made aligned.

FIG. 7 is a sectional view of a parabolic antenna 6C having a reflector 20C in which the engagement cylinder 22b is provided in a periphery part of a supporting body 14C. Because the supporting body 14C is of a dish shape, an engagement cylinder 22 provided in the side face of its periphery has a cylinder-like shape. In this case, the periphery part of a sub-reflector 16C functions as the engaged part 23b, and the sub-reflecting face 16a of the sub-reflector 16C and the supporting face 14a of the supporting body 14C function as an insertion amount regulation part.

As a result, when the sub-reflector 16C is bonded to the supporting body 14C, by fitting the engaged part 23b of the sub-reflector 16C into the engagement cylinder 22b, the axis line R4 of the sub-reflector 16C and the axis line R3 of the supporting body 14C can be made aligned. By the sub-reflecting face 16a hitting the supporting face 14a, a position of the sub-reflector 16C in a direction of the axis line R3 of the supporting body 14C is regulated.

Next, a fourth exemplary embodiment of the present invention will be described. Meanwhile, description will be omitted appropriately by using an identical symbol about a structure identical with a structure of the second exemplary embodiment. The supporting face of a supporting body in the second exemplary embodiment is a face which does not have a curvature in a radial direction like a side of a circular truncated cone. An adhesive material is applied to the whole surface of this supporting face, and a sub-reflector is bonded.

When a sub-reflecting face and a supporting face are formed into curved surfaces having a perfect similar figure, a thickness of an adhesive material at the time of bonding is of a very thin film. However, in practice, because there has a fabrication error when forming a sub-reflecting face and a supporting face, faces having a perfect similar figure cannot be formed. In particular, when a sub-reflecting face is of a hyperboloid or the like, it is difficult to make a supporting face be a perfect similar figure with a sub-reflecting face all over the surface. When a sub-reflecting face and a supporting face have such imperfect similar figures, because these faces come to contact with points, heterogeneity occurs to adhesive strength. Heterogeneity of adhesive strength may be a cause of such as peeling off of a sub-reflector.

Therefore, according to the fourth exemplary embodiment, it is arranged such that, without bonding a supporting face and a sub-reflector together all over the surface, a specified adhesion area (an area of an adhesive material storage part mentioned later) is provided, and the sub-reflector and the supporting body are bonded together in this area.

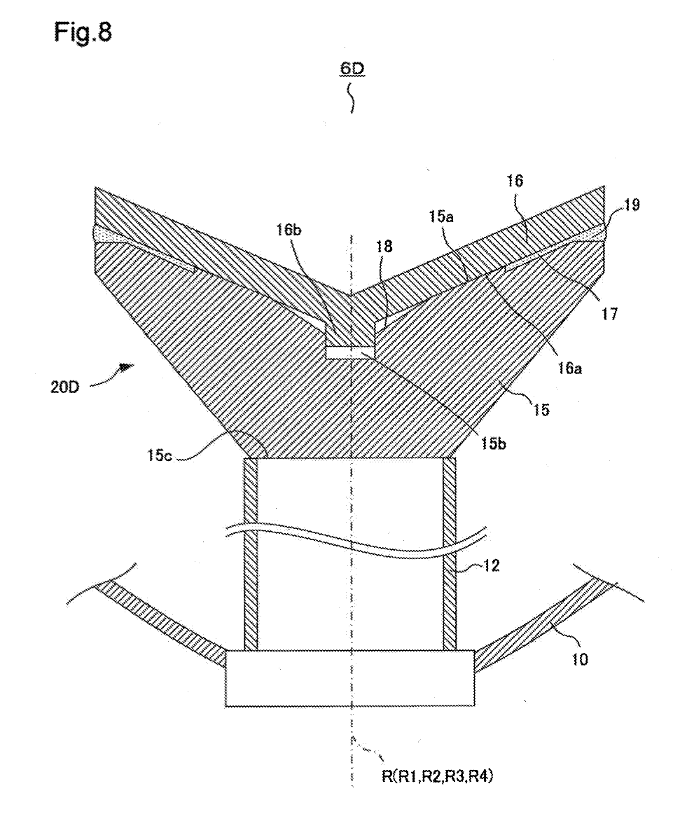

FIG. 8 is a sectional view of a parabolic antenna 6D having a reflector 20D according to the fourth exemplary embodiment. The structure of a supporting face of a supporting body is different from that of the parabolic antenna 6A shown in FIG. 2.

As shown in FIG. 8, a supporting body 15 in the parabolic antenna 6D according to the fourth exemplary embodiment includes a supporting face (insertion amount regulation part) 15a, an engaged part 15b and a fixing part 15c. An adhesive material storage part 17 and a terrace part 19 are formed in a peripheral part of a face of a supporting body 15 facing the sub-reflector 16, and an escape part 18 is formed in the axis line R3 side. That is, in the supporting body 15, the engaged part 15b, the escape part 18, a supporting face 15a, the adhesive material storage part 17 and the terrace part 19 are formed in order in the direction from the axis line R3 side toward the periphery. These engaged part 15b, the escape part 18, the supporting face 15a, the adhesive material storage part 17 and the terrace part 19 are circular trench bodies which take the axis line R3 as a center axis. The sub-reflector 16 and the supporting body 15 constitute the reflector 20D.

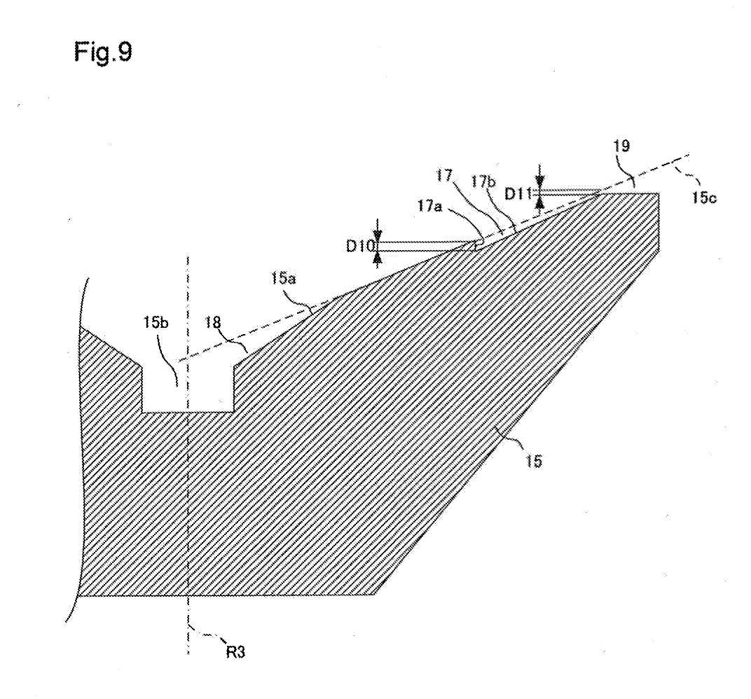

FIG. 9 is a partial grossly enlarged sectional view of the supporting body 15. Meanwhile, in the following description, a face which contacts with the supporting face 15a is described as an extended supporting face 15c. This extended supporting face 15c corresponds to the supporting face 14a in. FIG. 2. As FIG. 9 indicates a fragmentary sectional view of the supporting body 15, the extended supporting face 15c is being illustrated as a line.

The adhesive material storage part 17 includes a side face 17a in the axis line R3 side and a bottom face 17b to which an adhesive material is applied. The side face 17a is provided so that it becomes approximately parallel to the axis line R3. The adhesive material storage part 17 is formed so that the nearer a position is to the outer periphery side of the supporting body 15, the shallower a depth is. That is, the bottom face 17b approaches the extended supporting face 15c as an outer periphery side of the supporting body 15 is approached. Specifically, in FIG. 9, when it is supposed that the depth of the adhesive material storage part 17 at the side face 17a is D10, and the depth of the adhesive material storage part 17 at the boundary with the terrace part 19 is D11, it is such that D10>D11. The terrace part 19 is a face approximately vertical to the axis line R3. The escape part 18 is formed such that it dents from the extended supporting face 15c. Further, a cross-sectional shape of the escape part 18 can be determined arbitrarily.

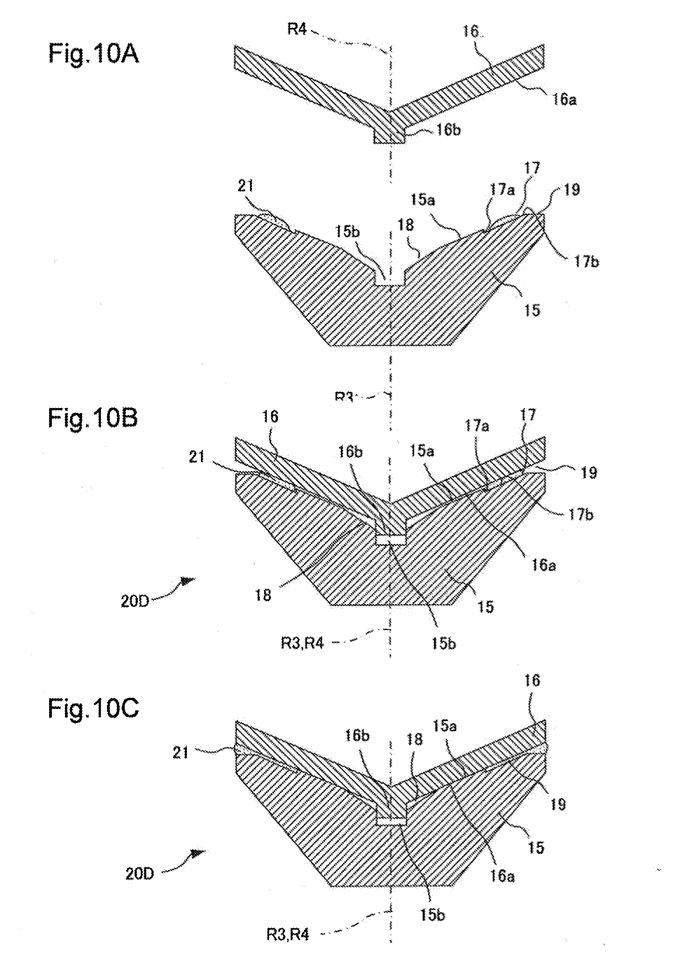

Operation of the adhesive material storage part 17 and the escape part 18 will be described with reference to FIGS. 10A-10C. FIGS. 10A-10C are sectional views of the supporting body 15 and the sub-reflector 16 which indicate a step for bonding the sub-reflector 16 to the supporting body 15. FIG. 10A is a sectional view when the sub-reflector 16 is facing the supporting body 15, and FIG. 10B is a sectional view when the sub-reflecting face 16a touches an adhesive material 21, and FIG. 10C is a sectional view when the sub-reflecting face 16a of the sub-reflector 16 touches the supporting face 15a.

As shown in FIG. 10A, at the time when the sub-reflector 16 is bonded, the adhesive material 21 is applied to the adhesive material storage part 17. On this occasion, the adhesive material 21 is applied so that the vertex of the adhesive material 21 projects from the extended supporting face 15c toward the sub-reflector 16 side, and it does not come in touch with the side face 17a.

When the sub-reflector 16 is moved from this state toward the supporting body 15 side, the sub-reflecting face 16a touches the adhesive material 21 as shown in FIG. 10B.

Because it is usually difficult to apply the adhesive material 21 of just a necessary amount to a bonded surface, the adhesive material 21 of more than a necessary amount is applied. Accordingly, the adhesive material 21 is extended by the sub-reflecting face 16a. The extended adhesive material 21 flows toward the axis line R3 side and the outer periphery side of the supporting body 15. Because a depth of the adhesive material storage part 17 becomes shallow in a direction toward the outer circumferential side from the side face 17a side, the adhesive material 21 flows toward the axis line R3 side by priority. However, because the side face 17a is provided in the axis line R3 side of the adhesive material storage part 17, the adhesive material 21 is stopped by this side face 17a.

On the other hand, because there is nothing which stops the adhesive material 21 in the outer periphery side of the adhesive material storage part 17, it flows even to the terrace part 19. When the adhesive material 21 flows, an air gap is buried by the adhesive material 17. Accordingly, an amount of the flowing adhesive material 21 becomes small gradually. However, because the depth of the adhesive material storage part 17 becomes shallow toward the outer circumferential side from the side face 17a side, the adhesive material 21 that flows toward the outer periphery side becomes as if it is squeezed. As a result, as shown in FIG. 10C, the space between the bottom face 17b of the adhesive material storage part 17 and the sub-reflecting face 16a is filled with the adhesive material 21, and thus only the remaining adhesive material 21 flows into the terrace part 19.

Because the space between the bottom face 17b of the adhesive material storage part 17 and the sub-reflecting face 16a become to be filled with the adhesive material 21, even if a fabrication error exists in the sub-reflecting face 16a and the supporting face 15a, uniform adhesive strength will work between the supporting body 15 and the sub-reflector 16.

On the occasion the adhesive material 21 is applied, it is applied such that the adhesive material 21 projects from the extended supporting face 15c toward the sub-reflector 16 side, and the adhesive material 21 does not touch the side face 17a. Accordingly, although the adhesive material 21 extended by the sub-reflecting face 16a is stopped by the side face 17a of the adhesive material storage part 17, there is a case where the adhesive material 21 of the slight amount climbs over the side face 17a of the adhesive material storage part 17 and flows to the supporting face 15a side, resulting in the sub-reflector 16 being bonded in the supporting face 15a.

Because the adhesive material 21 that flows into the supporting face 15a is slight as mentioned above, it is concerned that nonuniformity occurs to adhesive strength in this supporting face 15a, and it becomes a cause of such as peeling off of the sub-reflector 16.

However, because the supporting face 15a is surrounded by the adhesive material storage part 17 and the adhesive material 21 of the adhesive material storage part 17 shows uniform adhesive strength, the adhesive material 21 that has flowed to the supporting face 15a side will not be a cause of such as peeling off of the sub-reflector 16.

Next, operation of the escape part 18 will be described. The escape part 18 is provided in order to reduce a contact surface between the sub-reflecting face 16a and the supporting body 15. A position regulation in a direction of the axis line R4 of the sub-reflector 16 relative to the supporting body 15 is performed by contact of the sub-reflecting face 16a and the supporting face 15a which form an insertion amount regulation part. Accordingly, the supporting face 15a is not necessary to be of a large area and it only has to be a face or a point which contacts the sub-reflecting face 16a certainly. That is, the face of the supporting body 15 in the sub-reflector 16 side does not need to be a completely similar figure to the sub-reflecting face 16a. Therefore, according to the fourth exemplary embodiment, by providing the escape part 18, a cost needed when processing a face of the supporting body 15 in the sub-reflector 16 side into a completely similar figure to the sub-reflecting face 16a is reduced.

Meanwhile, in the above, it has been stated that a sub-reflecting face may be of a hyperboloid or the like. It will be a large cost increasing factor to form a supporting face such that it has a shape similar to a sub-reflecting face. However, as mentioned above, such cost increase can be prevented by providing an adhesive material storage part and by providing an escape part. That is, because, even when a sub-reflector is of a hyperboloid or the like, by applying an adhesive material such that it projects from the extended supporting face toward the sub-reflector side, the sub-reflector can be bonded certainly and a supporting face touches only a part of the sub-reflecting face, the supporting face does not need to be processed into a hyperboloid. Accordingly, by providing an adhesive material storage part, and by providing an escape part, the production cost can be suppressed.

Next, a fifth exemplary embodiment of the present invention will be described. Meanwhile, description will be omitted appropriately by using an identical symbol about a structure identical with a structure of the second exemplary embodiment.

In the second exemplary embodiment, in order to adjust a position of a sub-reflector relative to a supporting body, a position of the sub-reflector is adjusted so that an engaging part fits into an engaged part. In contrast, according to the fifth exemplary embodiment, a tapered part which works as an automatic alignment function is provided so as to be able to perform automatic adjustment.

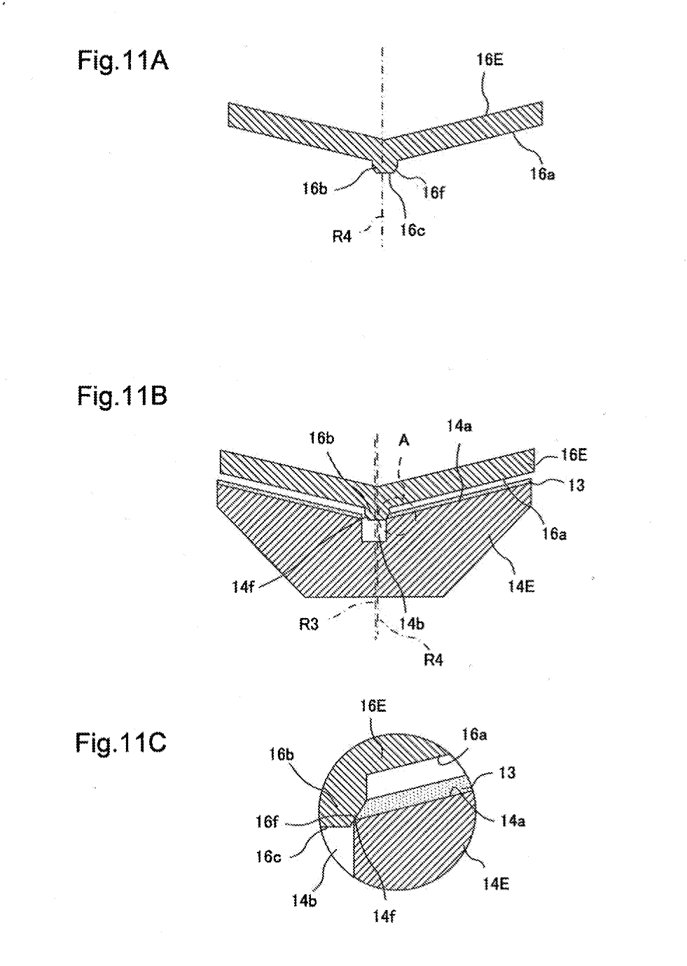

FIGS. 11A-11C are sectional views of a reflector 20E and a sub-reflector 16E in the fifth exemplary embodiment in which a tapered part is provided. FIG. 11A is a sectional view of a sub-reflector 16E equipped with such an engaging part 16b, FIG. 11B is a sectional view when bonding the sub-reflector 16E to a supporting body 14E in order to produce the reflector 20E, and FIG. 11C is a partial grossly enlarged sectional view of area A in FIG. 11B.

As shown in FIGS. 11A-11C, a tapered part 16f is formed in a corner of the engaging part 16b provided in the sub-reflector 16E in the end face 16c side. Meanwhile, a tapered part also includes a chamfered corner.

By thus forming a tapered part 16f in the corner of the engaging part 16b in the end face 16c side, when moving the sub-reflector 16E toward the supporting body 14E side, a positional displacement between the axis line R4 of the sub-reflector 16E and the axis line R3 of the supporting body 14E is self-adjusted.

That is, when the sub-reflector 16E is moved toward the supporting body 14E side in the state that the axis line R4 and the axis line R3 have a positional displacement, the tapered part 16f hits an edge 14f of the engaged part 15b as shown in FIG. 11B and FIG. 11C.

However, when sub-reflector 16E is moved further from the state that this tapered part 16f hits the edge 14f of the engaged part 15b toward the supporting body 14E side, the tapered part 16f is moved being guided by the edge 14f, and the engaging part 16b will fit into the engaged part 15b. Therefore, the axis line R4 of the sub-reflector 16E and the axis line R3 of the supporting body 14E can be made identical automatically.

Next, a sixth exemplary embodiment of the present invention will be described. Meanwhile, description will be omitted appropriately by using an identical symbol about a structure identical with a structure of the third exemplary embodiment. In the sixth exemplary embodiment, a tapered part which can adjust a position of a sub-reflector relative to a supporting body automatically is added to the reflector shown in FIG. 6.

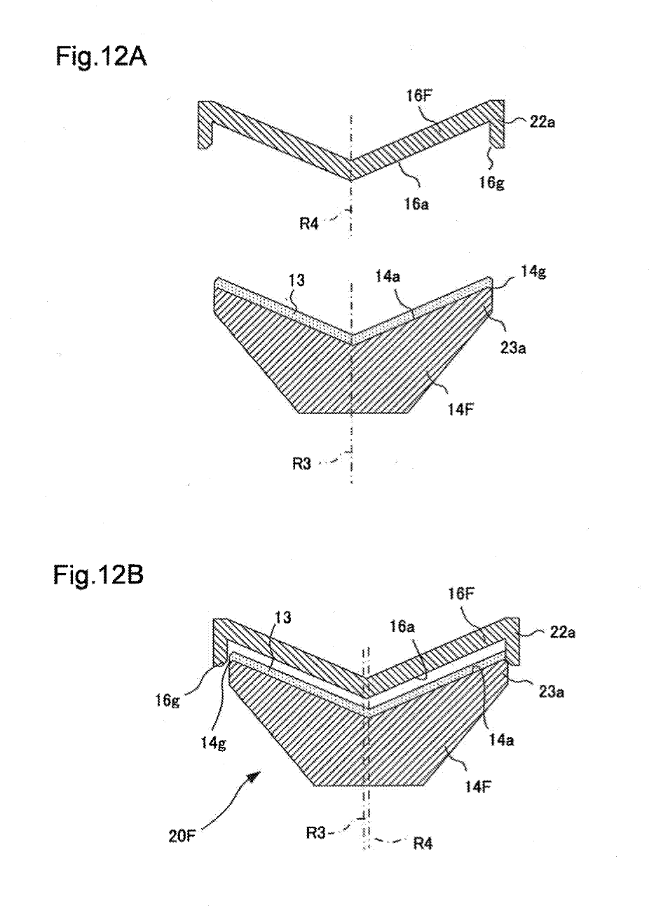

A reflector 20F according to the sixth exemplary embodiment will be described with reference to FIG. 12A and FIG. 12B. FIG. 12A is a sectional view of a sub-reflector 16F and a supporting body 14F when the sub-reflector 16F is facing a supporting body 14F, and FIG. 12B is a sectional view when bonding the sub-reflector 16F to the supporting body 14F.

As shown in FIG. 12A, a tapered part 16g is formed in the corner of the engagement cylinder 22a of the sub-reflector 16F in the axis line R4 side, and a tapered part 14g is formed in the corner of the supporting face 14a of the supporting body 14F in an outer periphery part.

Accordingly, when moving the sub-reflector 16F toward the supporting body 14F side, even if the axis line R4 of the sub-reflector 16F and the axis line R3 of the supporting body 14F cause a positional displacement and a tapered part 16g of the sub-reflector 16F hits the tapered part 14g of the supporting body 14F as shown in FIG. 12B, because the tapered part 16g moves along the tapered part 14g that is its counterpart, the positional displacement between the axis line R4 of the sub-reflector 16F and the axis line R3 of the supporting body 14F will be able to be self-adjusted.

Next, a seventh exemplary embodiment of the present invention will be described. Meanwhile, description will be omitted appropriately by using an identical symbol about a structure identical with a structure of the third exemplary embodiment. In the seventh exemplary embodiment, a tapered part which can adjust a position of a sub-reflector relative to a supporting body automatically is provided in the reflector shown in FIG. 7.

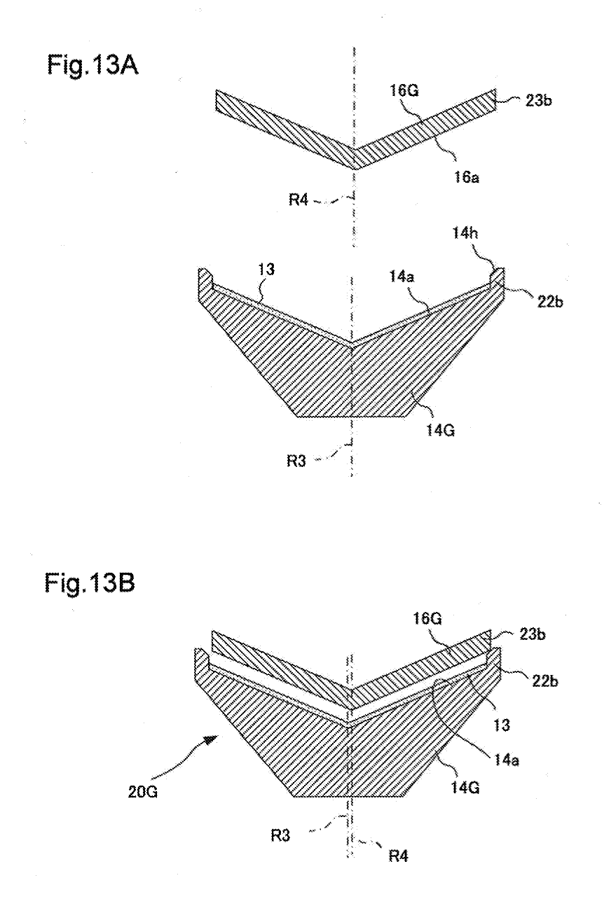

A reflector 20G according to the seventh exemplary embodiment will be described with reference to FIG. 13A and FIG. 13B. FIG. 13A is a sectional view of a sub-reflector 16G and a supporting body 14G when the sub-reflector 16G is made face the supporting body 14, and FIG. 13B is a sectional view when bonding the sub-reflector 16G to the supporting body 14G.

As shown in FIG. 13A, a tapered part 14h is provided in the corner of an engagement cylinder 22b of the supporting body 14G in the axis line R3 side. Accordingly, as shown in FIG. 13B, when moving the sub-reflector 16G toward the supporting body 14G side, even if the engaged part 23b hits the tapered part 14h, because the engaged part 23b moves being guided by the tapered part 14h, a positional displacement between the axis line R4 of the sub-reflector 16G and the axis line R3 of the supporting body 14G will be self-adjusted.

Next, a eighth exemplary embodiment of the present invention will be described. Meanwhile, description will be omitted appropriately by using an identical symbol about a structure identical with a structure of the second exemplary embodiment. In the second exemplary embodiment mentioned above, an engaged part is of a cylindrical hole. In an engaged part according to the eighth exemplary embodiment, an adhesion material dropping slot is added to this cylindrical hole.

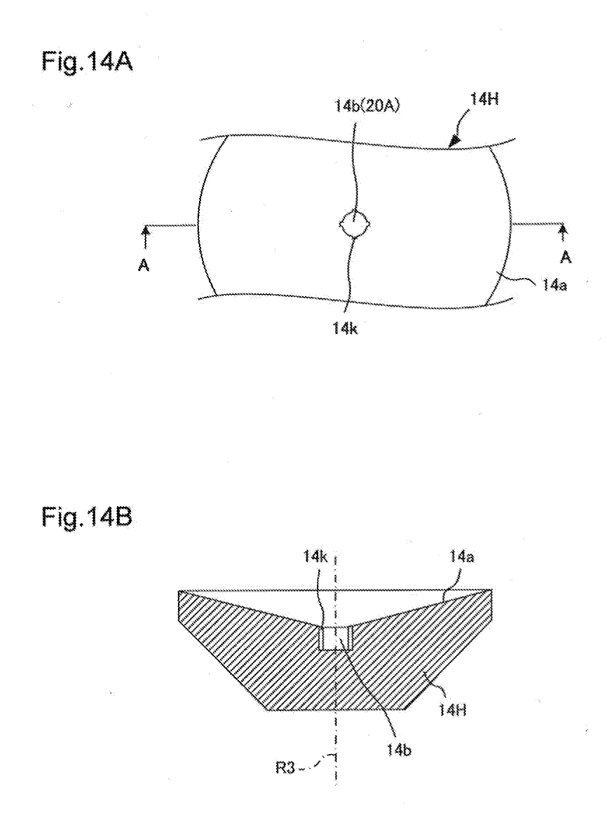

FIG. 14A is a partial top view of a supporting body 14H according to the eighth exemplary embodiment, and FIG. 14B is an arrowed cross-section diagram taken along line A-A of FIG. 14A. As shown in FIG. 14A and FIG. 14B, the supporting body 14H includes the engaged part 14b formed coaxially to the axis line R3, and a plurality of adhesion material dropping slot parts 14k formed along a lengthwise direction of this engaged part 14b. The adhesion material dropping slot parts 14k communicates with the engaged part 14b.

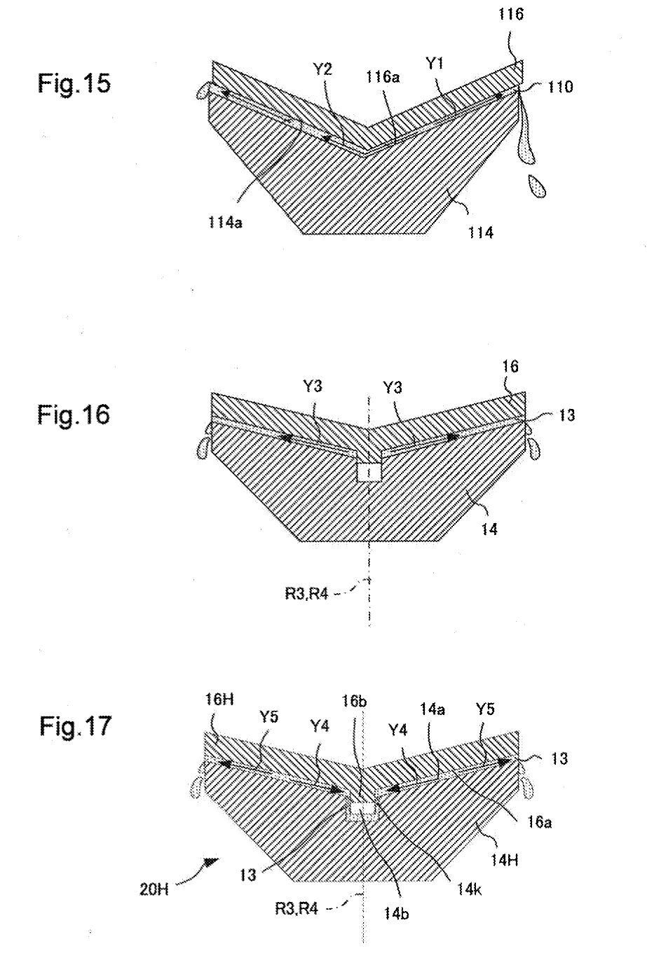

A behavior of the adhesive material 21 when bonding a sub-reflector 16H to the supporting body 14H having such adhesion material dropping slot parts 14k will be described with reference to FIGS. 15-17. FIG. 15 is a sectional view of the sub-reflector 116 and the supporting body 114 shown in FIGS. 5A-5C. FIG. 16 is a sectional view of the sub-reflector 16 and the supporting body 14 in the reflector 20A shown in FIG. 4. FIG. 17 is a sectional view of the sub-reflector 16H and the supporting body 14H according to the sixth exemplary embodiment.

In order to bond a sub-reflector and a supporting body together certainly, an adhesive material of an amount of more than the amount required for bonding is applied to a supporting face. Accordingly, when a sub-reflector is adhered to a supporting body, an extra adhesive material flows from a periphery of the supporting body to outside.

In the case of a reflector shown in FIG. 15 which does not have an engaged part, the adhesive material 110 that the sub-reflecting face 116a has touched first flows from a periphery part of the supporting body 114 to outside and also flows toward an area that has not been contacted yet. In FIG. 15, a flow path of the adhesive material 110 toward a periphery part is indicated by a flow path Y1, and a flow path of the adhesive material 110 that flows toward a not-yet-contacted area is indicated by a flow path Y2.

Generally, the adhesive material 110 is often a viscous fluid, and thus a large flow resistance works on the adhesive material 21 that flows along the flow path Y2 that is a long path. This flow resistance becomes resistance force when pressing the sub-reflector 116 toward the supporting body 114 side. Accordingly, a large reaction force acts on the sub-reflector 116, and determination whether the sub-reflecting face 116a has contacted to the supporting face 114a or not becomes difficult.

On the other hand, as shown in FIG. 16, when the reflector 20A has the engaging part 16b and the engaged part 14b, because the axis line R4 of the sub-reflector 16 can coincide with the axis line R3 of the supporting body 14 by the engaging part 16b fitting into the engaged part 14b, the adhesive material 13 flows approximately isotropically from the axis line R3 side of the supporting body 14 toward a periphery. In FIG. 16, a flow of this adhesive material 13 is indicated by a flow path Y3. Thus, because a flow path length of the adhesive material 13 can be made short, a reaction force from the adhesive material 13 that acts on the sub-reflector 16 can be made small.

However, even in such case, because the adhesive material 13 has to flow successively from a periphery part of the supporting body 14 approximately isotropically, the surplus adhesive material 13 in the axis line R3 side cannot flow easily from a periphery part of the supporting body 14 to outside.

Accordingly, in a reflector 20H according to the eighth exemplary embodiment, a plurality of adhesion material dropping slot parts 14k extending in the axial direction are provided in the inner wall (side face) of an engaged part 14b, and the flow of the adhesive material 13 is made split into two directions of the adhesive material 13 that flows toward the axis line R3 side and the adhesive material 13 that flows toward an outer periphery side.

As shown in FIG. 17, the adhesive material 13 that has flowed toward the axis line R3 side drops in the engaged part 14b from the adhesion material dropping slot parts 14k. The adhesive material 13 that has flowed toward an outer periphery side flows to outside. In FIG. 17, the adhesive material 13 that flows into the adhesion material dropping slot parts 14k is illustrated by a flow path Y4, and the adhesive material 13 that flows toward an outer periphery side is illustrated by a flow path Y5.

Thus, because, by the flow of the adhesive material 13 splitting into two directions, the surplus adhesive material 13 outflows from a bonded surface promptly without involving a large flow resistance, it will be able to be easily recognized that the sub-reflecting face 16a has touched the supporting face 14a. Accordingly, bonding work for bonding the sub-reflector 16H to the supporting body 14H becomes easy.

The present invention is not limited to the first to eighth exemplary embodiments described above, and various variations and modifications are possible within the range of the description of the claims. For example, a reflector is not limited to one for reflecting a reflective radio wave from a main-reflector of a parabolic antenna into a waveguide, and it may function as a first radiator. That is, a reflector may reflect a radio wave radiated from a waveguide to a main-reflector. An engaging part is not limited to a cylindrical body and it may be of a prismatic body. An engaging part only has to be a protrusion body and an engaged part only has to be a receiving hole which receives that.

Various modifications which a person skilled in the art can understand can be made to the composition and details of the present invention within the scope of the present invention.

This application claims priority based on Japanese application Japanese Patent Application No. 2009-123693 filed on May 22, 2009, the disclosure of which is incorporated herein in its entirety.

### DESCRIPTION OF SYMBOLS

3 Reflective body

3b Reflecting face (insertion amount regulation part)

3a and 16b Engaging part (insertion amount regulation part)

4, 14, 14B-14H, 15 Supporting body

4a, 14b, 14c, 15b, 23a and 23b Engaged part

4b, 14a and 15a Supporting face (insertion amount regulation part)

6A-6D Parabolic antenna

10 Main-reflector

12 Waveguide

14h, 14g, 16f and 16g Tapered part

14k Adhesion material dropping slot part

16 and 16B-16H Sub-reflector

16a Sub-reflecting face (insertion amount regulation part)

17 Adhesive material storage part

18 Escape part

20A-20H Reflective body apparatus

1-17. (canceled)

18. A reflector, comprising:
a reflective body which reflects a radio wave;
an engaging part which is formed in the reflective body;
a supporting body which supports the reflective body;
an engaged part which is formed in the supporting body and is engaged with the engaging part; and
an insertion amount regulation part which regulates an insertion amount when the engaging part engages into the engaged part.

19. The reflector according to claim 18, wherein
the engaging part is a protrusion body formed coaxially with an axis line of the reflective body, and
the engaged part, that is formed coaxially with an axis line of the supporting body, is a receiving hole for receiving the protrusion body.

20. The reflector according to claim 18, wherein
the insertion amount regulation part is a face of the reflective body and a face of the supporting body where the reflective body and the supporting body touch each other when the engaging part has been inserted into the engaged part.

21. The reflector according to claim 20, wherein
a length dimension of the engaging part is set to a dimension smaller than a depth dimension of the engaged part with a predetermined amount, and an insertion amount of the engaging part is regulated by the face of the reflective body and the face of the supporting body being in contact with each other without an end face of the engaging part and a bottom face of the engaged part being in contact with each other when the engaging part has been inserted into the engaged part.

22. The reflector according to claim 18, further comprising:
a plurality of adhesion material dropping slot parts which are formed in a side face of the engaged part.

23. The reflector according to claim 18, further comprising:
a tapered part which is provided in a corner of an end face of the engaging part.

24. The reflector according to claim 18, further comprising:
an adhesive material storage part for storing an adhesive material which is formed in a face of the supporting body touched by the reflective body.

25. The reflector according to claim 24, wherein
the adhesive material storage part is formed circularly to an axis line of the supporting body.

26. The reflector according to claim 24, wherein
a depth of the adhesive material storage part becomes shallow as an axis line of the supporting body becomes far.

27. The reflector according to claim 18, further comprising:
an escape part which lets the supporting body escape from contact with the reflective body when the engaging part is inserted into the engaged part.

28. The reflector according to claim 18, wherein
the engaging part is a cylindrical engagement cylinder formed in a periphery part of the reflective body or the supporting body, and the engaged part is a periphery part of the supporting body or the reflective body.

29. The reflector according to claim 28, further comprising:
a tapered part which is formed in a corner of a periphery part of the engaged part.

30. The reflector according to claim 28, further comprising:
a tapered part which is formed in an inside corner of an end of the engaging part.

31. The reflector according to claim 28, further comprising:
a tapered part which is formed in the engaged part of the supporting body fitting the engaging part.

32. The reflector according to claim 18, wherein
a length of the engaging part is less or equal than ¼ of a wavelength of a reflected radio wave.

33. The reflector according to claim 18, wherein
an inside diameter of the engaged part is less or equal than ¼ of a wavelength of a reflected radio wave.

34. A parabolic antenna comprising:
a main-reflector which reflects a radio wave;
a reflector which has
a reflective body which reflects a radio wave;
an engaging part which is formed in the reflective body;
a supporting body which supports the reflective body;
an engaged part which is formed in the supporting body and is engaged with the engaging part; and
an insertion amount regulation part which regulates an insertion amount when the engaging part engages into the engaged part; and
a waveguide, wherein
a radio wave reflected from the main-reflector is further reflected by the reflector, an is introduced inside the waveguide.
